(19) United States
(12) Patent Application Publication
(10) Pub. No.: US 2005/0284388 A1
(43) Pub. Date: Dec. 29, 2005

(54) Animal waste disposal system

(76) Inventor: Stacey L. Kunz, Ogden, UT (US)

Correspondence Address: STARKWEATHER & ASSOCIATES, 9035 S 1300 E, SUITE 200, SANDY, UT, 84094, US

(21) Appl. No.: 10/868,634

(22) Filed: Jun. 15, 2004

(51) Int. Cl. A01K 29/00

(52) U.S. Cl. 119/165

(57) ABSTRACT

The present invention provides a cabinet having upwardly extended sides with an aperture through at least one side configured to allow an animal to enter and exit the cabinet, a container for receiving a waste product from the animal and positioned within the cabinet and having a smooth surface and designed to form a funnel. The cabinet further comprises a cleaning vent, or cleaning aperture, through one of the sides configured to align with the funnel such that when a closing means is opened, the waste product in the container is released out of the cleaning vent. In one embodiment, the animal waste disposal system comprises a ramp that leads to the aperture to assist the animal in entering into the cabinet. In one embodiment, the animal waste disposal system comprises at least one shelf or drawer for storing items. Other embodiments comprise heaters, toe kicks, and braces for attaching the cabinet to a wall.

### BACKGROUND OF THE INVENTION

1. Field of the Invention

The present invention relates to an animal waste disposal system. Specifically, the present invention relates to a cabinet with a container for receiving waste from a cat and which facilitates the removal of the waste from the container and reduces odors.

2. Description of the Related Art

Pet litter boxes have long been used for collecting waste from household pets, such as cats and other domesticated animals that are kept indoors. Such litter boxes generally comprise a container holding a quantity of adsorbent materials such as sand or other adsorbent particles. Such adsorbent material adsorbs and holds the urine deposited by the pet and serves to desiccate and partially adsorb odor from feces deposited by the using pet.

The conventional litter box suffers from several disadvantages. First, the adsorbent material used therein is open to the environment and therefore, unprotected from other animals and curious children, and is easily spilled, or flung out of the container during use. Second, the adsorbent material is not one hundred percent effective at adsorbing the waste and odors and often smells after a single use. The smell is not contained in any type of housing, and could very well be a health hazard. Third, the litter boxes are difficult to clean as the waste matter sticks to the underlying container and the adsorbent material and waste in the container are often difficult to manipulate into a trash bag. Finally, litter boxes, and the waste deposited within the litter, are unsightly.

Various solutions for the above mentioned problems have been proposed. For example, many cat owners have simply moved the litter box outdoors. Although this helps eliminate the smell of the litter within the house, the cat does not have easy access to the litter when the cat is indoors.

Other pet owners have purchased easily disposable litter boxes so that the animal owner need never contact any animal waste and the litter can be changed often and easily. However, over time this can become costly if the owner is continually disposing of cat litter, box and all. Additionally, this solution may only partially eliminate the odor problem.

Other solutions have included providing fully enclosed boxes with one opening therein for the cat to enter and exit, in an attempt to contain the odors that often emanates therefrom. Such systems are little more than boxes that contain the odor, until the lid is removed.

Still other systems have gone high tech with sensors for determining when a cat has used the litter box and motors for removing the cat's waste. Although, possibly effective at automatically removing pet waste, the automatic system still suffers from many of the disadvantages discussed above.

It can be seen that there is a need for a system for animal waste that helps contain waste odors, that facilitates cleaning of the waste, that adequately holds the waste and litter in a container, and that houses unsightly views of the litter.

### SUMMARY OF THE INVENTION

The present invention has been developed in response to the present state of the art, and in particular, in response to the problems and needs in the art that have not yet been fully solved by currently available animal waste containers. Accordingly, the present invention has been developed to provide an animal waste disposal system that overcomes many or all of the above-discussed shortcomings in the art.

Specifically, the present invention provides a cabinet having upwardly extended sides with an aperture through at least one side configured to allow an animal to enter and exit the cabinet, and a container for receiving a waste product from the animal that is positioned within the cabinet and which has a smooth surface and forms a funnel. The cabinet further comprises a cleaning vent, or a cleaning aperture, through one of the sides configured to align with the funnel such that when a closing means is removed and the cleaning vent is opened, the waste product in the container is released out of the cleaning vent.

In one embodiment, the animal waste disposal system comprises a ramp that leads to the aperture to assist the animal in entering into the cabinet.

In another embodiment, the animal waste disposal system comprises at least one shelf or drawer for storing items.

Other embodiments comprise the use of heaters, toe kicks, and braces for attaching the cabinet to a wall.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention, as well as other features and advantages not listed, will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 illustrates a front view of an animal waste cabinet according to one embodiment of the present invention;

FIG. 2 illustrates a side cross-sectional view of an animal waste cabinet according to one embodiment of the present invention;

FIG. 3 illustrates a close up side view of a waste container and emptying means according to one embodiment of the present invention;

FIG. 4 illustrates a side view of a waste container and ramp according to one embodiment of the present invention; and

FIG. 5 illustrates a back view of a waste container according to one embodiment of the present invention.

### DETAILED DESCRIPTION OF THE INVENTION

For the purposes of promoting an understanding of the principles of the invention, reference will now be made to the exemplary embodiments illustrated in the drawings, and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

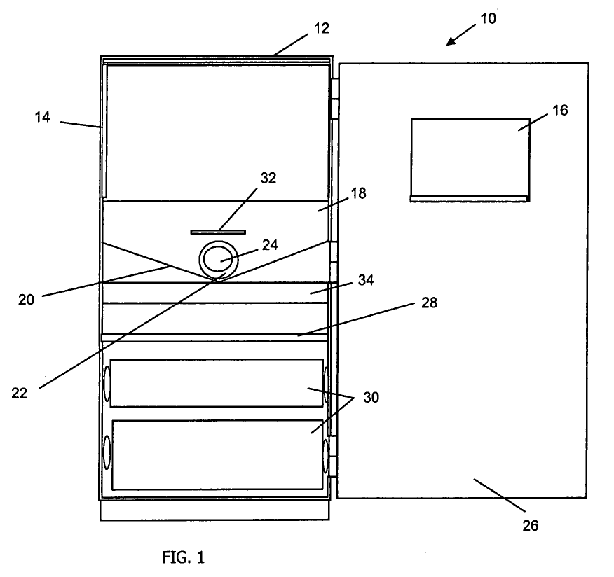

FIG. 1 illustrates a front view of an animal waste cabinet 10 according to one embodiment of the present invention. The animal waste cabinet 10 comprises a cabinet 12 having upwardly extended sides 14 with an aperture 16 through at least one side 14 configured to allow the animal to enter and exit the cabinet 12. A container 18 is positioned within the cabinet 12, wherein the container 18 has a smooth surface designed to form a funnel 20. The container 18 is configured to receive a waste product (not shown) from the animal (not shown). A cleaning vent, or more broadly, a cleaning aperture 22 passes through one end of the container 18 and aligns with the funnel 20 such that when a closing means 24 opens the cleaning vent 22, the waste product in the container 18 is released through the cleaning vent 22. The closing means may be any such means that is well-known in the art, such as a sliding door.

In one embodiment the aperture passes through a door 26 of the animal waste cabinet 10. The container 18 is elevated above a shelf 28 and a plurality of drawers 30 configured to hold items. The shelf 28 and drawers 30 are configured to slide in and out of the cabinet 12 to allow access to the contents inside and to use the shelf 28 as a support or table top.

The container 18 is configured to slide in and out of the cabinet 12 to facilitate cleaning of a surface of the container 18. A handle 32 may be attached to a side of the container to pull the container 18 from out of the cabinet 12. The surface of the container 18 is smooth to prevent animal waste from sticking. In a preferred embodiment, the container 18 comprises a ceramic or stainless steel layer, or other material that decreases the risk of animal waste sticking to the surface. The entire container 18 may be made of the non-stick material, or just a portion of the container 18 that is exposed to the animal waste.

A heating element 34 positioned below the container 18 heats the cabinet 10 and dries the contents (not shown) resting on the container 18. The contents may be any type of adsorbent material such as kitty litter, wood chips, sand, etc.

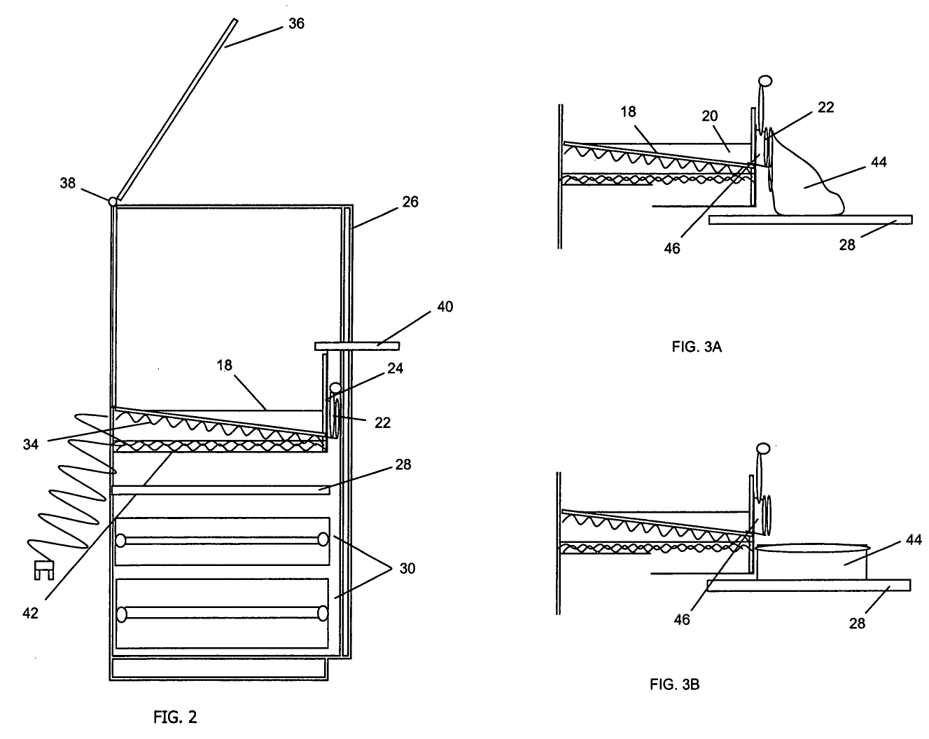

FIG. 2 illustrates a side cross-sectional view of an animal waste cabinet according to one embodiment of the present invention. A lid 36 opens about a pivot point, or hinge 38 to allow easy access to the container 18. A ledge 40 protrudes from the door 26 for the animal to rest on before entering the cabinet 12.

In one embodiment, the heating element 34 attaches to a bottom side of the container 18. The heating element 34 is a coil type heater configured to transfer heat to the container 18 to maintain the cabinet 12 at a constant temperature and to dry the animal waste. The heating element 34 may be configured with a timer (not shown) and/or temperature gauge (not shown) to allow greater control of the amount of energy used and the time and temperature that the heater will be used. Additionally, the heating element 34 may be configured with a sensor (not shown) attached to an inside of the bottom of the container 18 and configured to heat the container 18 when the sensor determines that moisture exists in the container 18. The heating element 34 may automatically switch off when the sensor determines that the moisture has dried.

A heat shield 42 may be positioned below the heating element 34 to block heat from passing to the shelf 28 and the drawers 30.

As discussed above, the shelf 28 and drawers 30 may be configured to slide in and out of the cabinet 12 to allow easy access to the contents within the drawers 30.

FIG. 3 illustrates a close up side view of a container 18 and emptying means according to one embodiment of the present invention. The cleaning vent 22 of the container 18 opens at a lower portion of the container 18 so that the contents (not shown), and waste products produced by the animal, flow off the container 18 and through the cleaning vent 22. The funnel 20 guides the contents out of the cleaning vent 22 into a waste container 44. The waste container 44 may be a bag, a box, a bowl, or any other means for holding the waste. The shelf 28 may be used to hold the waste container 44 while the contents empty.

In one embodiment, side portions of the container 18 angle upwards and a back edge of the container angles towards an opposite end of the container 18 to form the funnel 20. The funnel 20 may be curved or it may have straight edges where the side portions angle.

In the illustrated embodiment, the closing means 24 is a plate that rotates about an axis point (not shown) to open the cleaning vent 22. In the illustrated embodiment, the closing means 24 is set back into a tube 46 of the cleaning vent 22, which is configured to guide the waste from the funnel 20 to the waste container 44. In operation, when the closing means 24 is opened, the contents of the container 18 flow through the tube 46 into an awaiting container 44 resting on the shelf 28. As an example, a bag may be used such that the opening of the bag can wrap around the tube 46 of the cleaning vent 22 to ensure that the contents leaving the container 18 are entirely received into the bag.

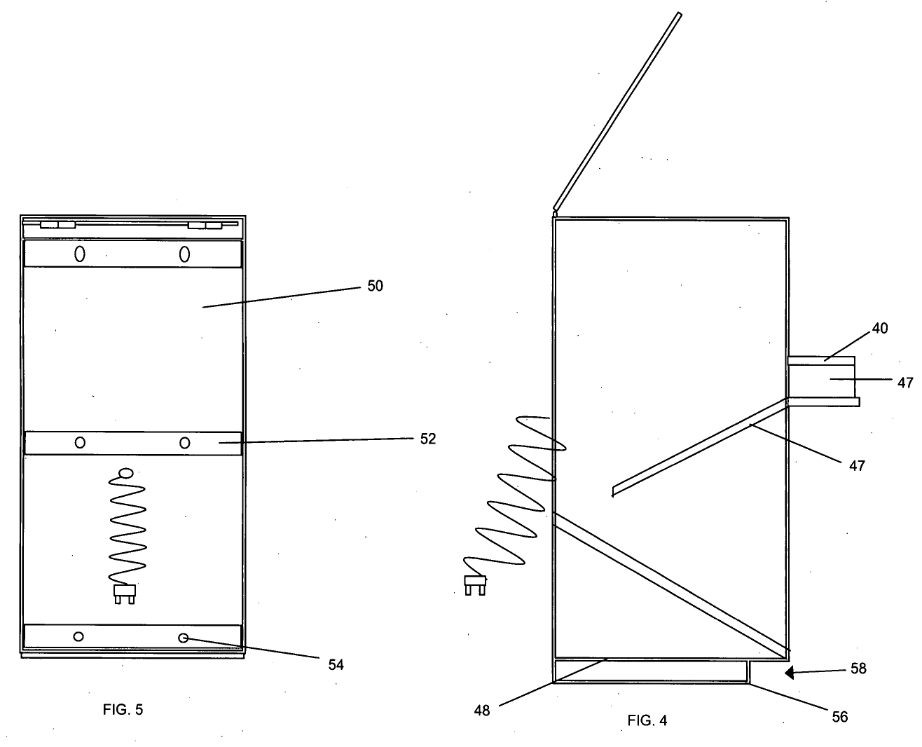

FIG. 4 illustrates a side view of an animal waste cabinet 10 and ramp 47 according to one embodiment of the present invention. The ramp 47 is configured to run at a predetermined angle from a base 48 of the animal waste cabinet 10 to the ledge 40 at the opening of the aperture 16. In one embodiment, the ramp traverses a single side 14 of the animal waste cabinet 10 by criss-crossing. In another embodiment, the ramp 47 comprises a plurality of sections, which traverse the animal waste cabinet 10 on each side 14. The ramp 47 may be fastened to the animal waste cabinet 10 by any means including screwed, glued, welded, etc.

FIG. 5 illustrates a back view of the animal waste cabinet 10 according to one embodiment of the present invention. The back side 50 of the animal waste cabinet 10 comprises a plurality of wall braces 52 for securing the animal waste cabinet 10 to a stable structure. Holes 54 passing through the wall braces 52 may be accessed from inside the animal waste cabinet 10.

It is understood that the above-described arrangements are only illustrative of the application of the principles of the presently illustrated invention. The present invention may, however, be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

For example, although the illustrative embodiment(s) show that the animal waste cabinet 10 is configured to be stationary, it is envisioned that wheels may be fastened to a base 56 (See FIG. 5) of the animal waste cabinet 10 to enable the owner to move the animal waste cabinet 10 to any location. The wheels may be configured to raise and lower the cabinet 10 to improve stability when the cabinet 10 is not being used.

It is also envisioned that the base 56 of the cabinet 10 may further comprise a toe kick 58 (See FIG. 4) for enabling the owner to get closer to the cabinet 10 for cleaning purposes.

Although the specification discusses the use of a door 26 for enabling the owner to access the contents within the cabinet 10, it is envisioned that all sides 14 of the cabinet 10 may be configured to open.

Finally, it is envisioned that the cabinet 10 may be configured with a variety of other devices, including ventilation fans, lights, locks on the door 26 and drawers 30, hoses for connecting to water sources for cleaning the container, and apertures 16 with adjustable size control for controlling the size of animals that are permitted enter.

Thus, while the present invention has been fully described above with particularity and detail in connection with what is presently deemed to be the most practical and preferred embodiment(s) of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims.

1. An animal waste disposal system, comprising:
a cabinet having upwardly extending sides with an entrance aperture through at least one side;
a container positioned within the cabinet and having a smooth surface forming a funnel at one end, wherein the funnel comprises:
a lower end; and
an aperture coplanar with an upwardly extending side; and
a cleaning aperture aligned with the aperture of the funnel so that waste product in the container is released through the cleaning aperture.

2. The system according to claim 1 further comprising a lid movably engaging a top of the cabinet configured to allow access to the container.

3. The system of claim 1 wherein the funnel is formed by angling sides of the container toward a center of the container and angling one end of the container towards an opposite end of the container.

4. The system of claim 3 wherein the container is held at an elevated position within the cabinet and positioned above at least one storage unit.

5. The system of claim 1 wherein at least one side opens to allow access to the cabinet.

6. The system of claim 1 further comprising a heating element configured to heat an inside of the cabinet.

7. The system of claim 4 further comprising at least one shelf and at least one drawer, wherein the shelf has a storage position and a supporting position and is configured to facilitate collection of waste material when in the supporting position.

8. A system for containing animal waste comprising:
a cabinet having upwardly extended sides with an entrance aperture through at least one of the upwardly extending sides;
a ramp-like structure attached to the sides of the cabinet and leading to the entrance aperture;
a container positioned within the cabinet and having a smooth surface, wherein the container includes:
a lower end; and
an aperture coplanar with an upwardly extended side;
a cleaning aperture through one of the sides, and aligned with the aperture of the container; and
a closing means positioned over the cleaning aperture and configured to release the animal waste from the container when the closing means is opened.

9. The system according to claim 8 further comprising a lid movably engaging a top of the cabinet configured to allow access to the container.

10. The system according to claim 8 wherein the container is designed to form a funnel and is configured to align with the cleaning aperture such that when the closing means is opened, contents in the container flow out of the cleaning aperture.

11. The system of claim 10 wherein the funnel is formed by angling sides of the container toward a center of the container and angling one end of the container towards an opposite end of the container.

12. The system of claim 8 wherein the container is held at an elevated position within the cabinet and positioned above at least one storage shelf.

13. The system of claim 8 wherein at least one side opens to allow access to the cabinet.

14. The system of claim 8 further comprising a heating element configured to heat an inside of the cabinet.

15. An animal waste disposal system comprising:
a cabinet having upwardly extended sides with an entrance aperture through at least one of the upwardly extending sides;
a ramp-like structure attached to the sides of the cabinet and leading to the entrance aperture;
a container positioned within the cabinet having a smooth surface and forming a funnel at one end, wherein the funnel comprises:
a lower end; and
an aperture coplanar with an upwardly extended side;
a cleaning aperture aligned with the aperture of the funnel so that when the cleaning aperture is opened contents in the container exit the cabinet laterally through the cleaning aperture; and
a closing means positioned over the cleaning aperture configured to release contents from the container.

16. The system according to claim 15 further comprising a lid movably engaging a top of the cabinet configured to allow access to the container.

17. The system of claim 15 wherein the funnel is formed by angling sides of the container toward a center of the container and angling one end of the container towards an opposite end of the container.

18. The system of claim 15 wherein the container is held at an elevated position within the cabinet and positioned above at least one storage shelf, wherein the storage shelf has a storage position and a supporting position and is configured to facilitate collection of waste material when in the supporting position.

19. The system of claim 15 wherein at least one side opens to allow access to the cabinet.

20. The system of claim 15 further comprising a heating element attached to a bottom side of the container, and configured to warm the container.
